(19) United States
(12) Patent Application Publication
(10) Pub. No.: US 2018/0055279 A1
(43) Pub. Date: Mar. 1, 2018

(54) Mixed Drink Producing Apparatus With An Overall Container With Multiple Chambers As Well As Household Refrigeration Apparatus With A Mixed Drink Producing Apparatus

(71) Applicant: BSH HAUSGERAETE GMBH, Muenchen (DE)

(72) Inventors: KUDRET BAYSAL, GIENGEN BRENZ (DE); CARSTEN WEISS, GIENGEN (DE)

(21) Appl. No.: 15/252,521

(22) Filed: Aug. 31, 2016

(51) Int. Cl. A47J 31/46; B01F 15/06; B01F 15/02; F25D 23/12; B67D 1/00

(52) U.S. Cl. CPC A47J 31/462; B01F 15/06; B01F 15/0243; B01F 15/026; B01F 2015/061; B67D 1/0021; B67D 1/0078; B01F 2215/0022; F25D 23/12

(57) ABSTRACT

A mixed drink producing apparatus for a household refrigeration apparatus with a first dispensing container, which is formed for receiving a first liquid having a first freezing point and addable to a mixed drink by the mixed drink producing apparatus and which is connected to a dispensing unit of the mixed drink producing apparatus for conducting the first liquid from the first dispensing container to the dispensing unit, and with at least one second dispensing container, which is formed for receiving a second liquid having a second freezing point different from the first freezing point and addable to a mixed drink by the mixed drink producing apparatus and which is connected to the dispensing unit of the mixed drink producing apparatus for conducting the second liquid from the second dispensing container to the dispensing unit, wherein the first dispensing container and the second dispensing container are formed as chambers in an overall container, and the chamber of the first dispensing container is separated from the chamber of the second dispensing container by at least one partition in the overall container. It can also be provided that a storage container is formed as a chamber in the overall container.

### TECHNICAL FIELD

The invention relates to a mixed drink producing apparatus with a first dispensing container, which is formed for receiving a first liquid addable to a mixed drink by the mixed drink producing apparatus. The first dispensing container is connected to a dispensing unit of the mixed drink producing apparatus for conducting the first liquid from the first dispensing container to the dispensing unit. The mixed drink producing apparatus includes at least one second dispensing container, which is formed for receiving a second liquid addable to a mixed drink by the mixed drink producing apparatus. The second dispensing container is also connected to the dispensing unit of the mixed drink producing apparatus for conducting the second liquid from the second dispensing container to the dispensing unit. Furthermore, the invention also relates to a household refrigeration apparatus with a mixed drink producing apparatus.

### PRIOR ART

From DE 196 15 106 A1, a method and a device for continuously producing soda water or soda-like water are known. A device is disclosed there, in which different liquids like lemonade, beer, wine can be present in different separate containers. Each container is connected to an own tap and is thus separated from the other container. Producing and dispensing a mixed drink of different liquids in the containers is not possible there in the interior of the system itself. Furthermore, the taps are far apart such that introducing liquids from different taps into a drinking vessel at the same time is not possible.

From WO 2007/141321 A2, a household refrigeration apparatus is known, which is formed as a drink apparatus for dispensing a drink at this household refrigeration apparatus itself.

Moreover, cold drink machines are also known, in which alcohol containing mixed drinks, for example cocktails, can be dispensed.

In such mixed drink producing apparatuses for producing cooled mixed drinks, the number of the individual containers is high and the space requirement is large. Moreover, extensive line connections are required for these separate, spaced containers.

### BRIEF SUMMARY OF THE INVENTION

It is the object of the present invention to provide a mixed drink producing apparatus as well as a household refrigeration apparatus, in which the space requirement for dispensing containers of liquids for the mixed drink is reduced.

This object is solved by a mixed drink producing apparatus and a household refrigeration apparatus according to the independent claims.

According to a first independent aspect of the invention, a mixed drink producing apparatus is provided, which has a first dispensing container. The first dispensing container is formed for receiving a first liquid in particular having a first freezing point and addable to a mixed drink to be dispensed by the mixed drink producing apparatus. This first dispensing container is connected to a dispensing unit of the mixed drink producing apparatus for conducting the first liquid from the first dispensing container to the dispensing unit. The mixed drink producing apparatus moreover includes at least one second dispensing container, which is formed for receiving a second liquid in particular having a second freezing point different from the first freezing point and addable to a mixed drink to be dispensed by the mixed drink producing apparatus. The second dispensing container is connected to the dispensing unit of the mixed drink producing apparatus for conducting the second liquid from the second dispensing container to the dispensing unit. An essential idea of this first independent aspect of the invention is to be regarded in that the first dispensing container and the second dispensing container are formed as chambers in a single common overall container, wherein these chambers and thus also the dispensing containers are separated by at least one partition in the overall container. By such a configuration, an integration of multiple dispensing containers in a single overall container is virtually allowed. Thereby, the space requirement for the two dispensing containers is considerably reduced and line connections between separate dispensing containers, which are positioned spaced from each other, either are not required. Thereby, the component requirement of the mixed drink producing apparatus is also reduced.

In particular, it is provided that the chambers of the dispensing containers are formed one above the other viewed in vertical direction of the mixed drink producing apparatus. By this tower-like construction, a very narrow overall container is allowed.

In particular, it is provided that the first dispensing container is formed for receiving a first liquid with a higher freezing point than the second liquid and the chamber of the first dispensing container is formed below the chamber of the second dispensing container viewed in vertical direction. Here, besides optionally fluidically advantageous configurations, cooling of the liquid in the upper chamber and in the lower chamber can then also be effected in improved manner.

In particular, it is provided that a volume area is formed as a thermal insulation area between the chambers. Thereby, a buffer zone is virtually provided, which avoids that the liquid with the higher freezing point would be frozen by the liquid with the lower freezing point at least in certain areas.

In an advantageous configuration, it is provided that the thermal insulation area is an air volume. Thereby, an objective further solid material or other thermal insulating material does not have to be attached, but sufficient thermal separation between these two chambers is provided by this air volume alone. In particular, this thermal insulation area is formed in one of the two chambers such that an additional separate and separated volume area does not have to be formed in addition to the two chambers.

In particular, it is provided that the thermal insulation area is bounded to the top by the partition and is dimensioned to the bottom by a mark spaced from the partition and presenting a maximum filling level boundary for filling of the dispensing container with the liquid to be introduced therein. This thermal insulation area is therefore bounded and defined by objective elements present anyway such that here too additional elements are not required at all. The sufficient dimensioning of this thermal insulation area is thereby given and also simply recognizable for a user. Filling beyond the filling level boundary is not to be provided anyway, such that by this in particular present mark a filling level of the liquid is also preset, by which influence with regard to freezing by the liquid from the other chamber is prevented.

In particular, it is provided that the mixed drink producing apparatus has a refrigeration circuit, to which at least one dispensing container of the overall container and thus the corresponding chamber is thermally coupled and thereby the chamber can be cooled. By such a configuration, a very efficient and adequate cooling at least of one dispensing container is allowed and thus a correspondingly desired and exact cooling of this liquid is then also allowed if the liquid to be introduced therein is present in this dispensing container and thus also in this chamber.

Preferably, it is provided that the refrigeration circuit has a first evaporator, which is thermally coupled to the chamber to be cooled of the dispensing container to be cooled of the overall container, and/or has a second evaporator, which is thermally coupled to the further chamber to be cooled of the further dispensing container to be cooled. In that individual single evaporators are then virtually present for the individual chambers, the adequate cooling can then be improved. Then, the cooling can in particular also be effected independently of the respective other chamber and the individually desired temperatures of the respective chambers can be faster achieved and be more exactly adjusted and maintained.

Preferably, it is provided that the refrigeration circuit is thermally coupled to both dispensing containers and thus both chambers and both chambers of the dispensing containers can be cooled by the refrigeration circuit.

In particular, it is provided that the mixed drink producing apparatus is arranged with a liquid line for conducting a liquid of a dispensing container extending in the chamber of the other dispensing container in sections such that cooling of the liquid flowing in the line is effected by the liquid located in the chamber, in which the line is disposed extending, or cooling of the liquid in the line is effected by the liquid located in this chamber. In this alternative configuration too, the respective cooling of the liquids can be very adequately effected and a refrigeration circuit in particular with one or more evaporators, a condenser and a compressor for both dispensing containers is not required, but only for one. For example, the cooler liquid is conducted via a conveying line, which is laid in the chamber with the warmer liquid in certain areas, and the warmer liquid is thereby also cooled. Similarly, it can be provided that the warmer liquid in a conveying line, which leads away from the chamber with the warmer liquid and again joins thereto, is laid through the chamber with the colder liquid at least in sections, and by this thermal coupling the warmer liquid flowing in the conveying line is then cooled by the colder liquid. In this context, configurations very adapted to situation can be realized, which are individually configured with regard to the respective space requirement, respective functionalities and the respective cooling requirements and allow respective individual cooling scenarios. A very compact construction is achieved in all of these implementations.

In particular, it is provided that the mixed drink producing apparatus has a pump, by which liquid in the liquid line can be pumped off at least from the section extending in the chamber if cooling is not required. This is a further very advantageous implementation since undesired freezing thus is not effected with non-flowing liquid and thus liquid standing in the liquid line.

In particular, it is provided that the mixed drink producing apparatus has at least one storage container for storing the liquid of the associated dispensing container in addition to the first dispensing container and/or to the second dispensing container, wherein the storage container is connected to the associated dispensing container for conducting the liquid from the storage container to the associated dispensing container, and the storage container is formed as a chamber in the common overall container. In this context, such a concept allows providing a larger amount of a certain liquid in the mixed drink producing apparatus. By providing a dispensing container for a liquid and a further storage container for this liquid, individual preparations for the respective liquid amounts of this same liquid can also already be effected besides increased storage capacities. Thus, different temperatures for this liquid in the storage container and in the associated dispensing container can for example be adjusted such that a certain pre-cooling can for example already be effected in the storage container. A cooling in the dispensing container then required is no longer required or no longer required to a correspondingly large extent. In that this storage container, which is then also again formed separated from the associated dispensing container in the overall container, is also integrated in the overall container, compact configuration of the containers can still be allowed even in this configuration with an increase of the number of containers. A further advantage is given in that a liquid can thus be relatively warm refilled, in particular into the storage container, without having to be severely cooled before. In particular, refilling of a relatively warm liquid can be effected without the dispensing of drinks having to be interrupted since cooled liquid is present in the dispensing containers.

In particular, it can be provided that a first storage container is present, which is provided for storing a first liquid and connected to the first dispensing container for conducting the first liquid. In addition, a second storage container separated therefrom is provided, in which the second liquid can be stored, wherein the second storage container is then connected to the second dispensing container for conducting the second liquid also into the second dispensing container. In this constellation, each dispensing container then has an individually associated storage container such that the liquids respectively stored therein can also be individually processed or prepared, as it was already above explained. The further storage container is also in particular formed as a chamber in the overall container.

Here, it is then preferably provided that the arrangement of a storage container and an associated dispensing container is effected one above the other viewed in height direction of the household refrigeration apparatus and preferably the storage container is disposed above the dispensing container. In such a configuration, an in particular present pump for conveying the liquid from the storage container into the associated dispensing container can then be replaced with a simple valve such that upon opening the valve the liquid then flows from the storage container into the associated dispensing container solely by gravity.

In the configuration, in which two dispensing containers are formed as chambers in the overall container and are disposed one above the other in vertical direction, that dispensing container and thus the corresponding chamber is preferably formed further up, in which the liquid with the lower freezing point is to be received.

In an implementation, in which each one storage tank or storage container and the at least two dispensing containers are present, which are connected to the respective provided storage containers for conducting the respective liquid, with a vertical arrangement of the chambers presenting the storage containers and the chambers presenting the dispensing containers in an overall container, it is preferably provided that the storage container for the liquid with lower freezing point is located at the top, then following downwards the dispensing container for this liquid with the lower freezing point follows, then again subsequently downwards the storage container for the further liquid with the higher freezing point and then again downwards directly following the dispensing container for the liquid with the higher freezing point is formed.

By such a configuration, the possibility of icing of the liquid with the higher freezing point is then also considerably reduced.

Furthermore, the invention also relates to a household refrigeration apparatus with a housing, in which a receiving space for food is formed, wherein the household apparatus has a mixed drink producing apparatus according to the first independent aspect of the invention or an advantageous configuration thereof.

A further independent aspect of the invention relates to a drink producing apparatus, in particular a mixed drink producing apparatus with a dispensing container, which is formed for receiving a first liquid in particular having a first freezing point addable to a drink by the drink producing apparatus. This dispensing container is connected to a dispensing unit of the drink producing apparatus for conducting the first liquid from the dispensing container to the dispensing unit. An essential idea of the second independent aspect of the invention is to be regarded in that the drink producing apparatus has a first storage container for storing this liquid in addition to the first dispensing container, wherein the storage container is connected to the dispensing container for conducting the liquid from the storage container to the dispensing container and the dispensing container and the storage container are formed as individual chambers in a common overall container. Thereby, a very compact and space saving construction of the container system of the drink producing apparatus can be achieved. Additional extensive line connections between the storage container and the dispensing container are not required as it would be the case with separate containers disposed spaced from each other.

In particular, it is provided that the chambers of the dispensing container and the storage container are formed one above the other viewed in vertical direction of the mixed drink producing apparatus. In particular, it is provided that the chambers are separated by a partition directly adjoining to each other. In particular, a liquid passage element is formed in the partition, by which the chambers are connected for conducting liquid from the storage container into the dispensing container. The liquid passage element is formed for defined passage of the liquid. Thereby, an exactly metered supply of the liquid from the chamber presenting the storage container into the chamber presenting the dispensing container is allowed in terms of quantity and/or time. If such a liquid line is not provided, thus, this is then also prevented by the liquid passage element.

In particular, the liquid passage element is a valve or a unidirectional membrane. These components are very functionally safe and still small and compactly constructed.

In particular, it is provided that the storage container is a cooling container, in which liquid can be stored cooled at a temperature, which is equal to or higher than the temperature of this liquid in the dispensing container, wherein cooling of the liquid in the storage container can be performed in particular depending on the temperature of the liquid, in particular to a temperature as it is desired in the dispensing container. Thereby, cooled storage of the liquid in the storage container is allowed. Thereby, germ formation is also prevented. In addition, cooling demand in the dispensing container is no longer required or only to low extent since by the pre-cooling in the storage container, liquid already has the desired temperature in introducing into the dispensing container or only a considerably reduced cooling demand is then required in the dispensing container.

In particular, it is provided that the mixed drink producing apparatus has at least one further dispensing container, which is formed for receiving a second liquid having a second freezing point different from the first freezing point and addable to a mixed drink by the mixed drink producing apparatus. This further dispensing container is connected to the dispensing unit of the mixed drink producing apparatus for conducting the second liquid from the further dispensing container to the dispensing unit, wherein the further dispensing container is in particular also formed as a chamber in the overall container.

Here too, the invention additionally relates to a household refrigeration apparatus with a housing, in which a receiving space for food is formed, wherein the household refrigeration apparatus has a mixed drink producing apparatus according to the second independent aspect of the invention or an advantageous configuration thereof.

Advantageous implementations of the first independent aspect of the invention are to be regarded as advantageous implementations of the second independent aspect of the invention, wherein this also correspondingly applies vice versa.

In addition, it can also be provided that the mixed drink producing apparatus is formed for receiving a capsule, in which additives, which can be added to the mixed drink. Additives can be powdery or gelatinous or also liquid. In this context, the capsule can then be inserted into a dispensing area of the mixed drink producing apparatus and this ingredient of the capsule can then also be automatically dispensed or added or already be added upon dispensing the mixed drink.

In an advantageous implementation, it is provided that the mixed drink producing apparatus is disposed in a receiving area of the household refrigeration apparatus in particular separate from the receiving space for food. This receiving area can be formed in an interior container bounding the receiving space with its walls. However, it can also be provided that the receiving area is formed in an interior container separate from this interior container bounding the receiving space with its walls. These interior containers or this interior container are or is disposed in the housing.

The receiving space, in particular only the receiving space, is closable on the front side by a door pivotably supported at the housing. In this context, it can be provided that the household refrigeration apparatus is formed such that only one receiving space is present, which is for example a refrigerating compartment or a freezing compartment, which is closable by an own door. However, it can also be provided that such a single receiving space is closable by two doors, which are swing doors. However, it is similarly possible that with two separate receiving spaces, for example a refrigerating space and a freezing space, each of these receiving spaces is closable by a separate door.

Preferably, the mixed drink producing apparatus is accessible and exposed on the front side and not closed and covered by a door.

In an advantageous implementation, it is provided that the mixed drink producing apparatus is arranged drawer-like in the receiving space and thus is retractable and extractable in depth direction of the household refrigeration apparatus. Thereby, the operability for dispensing mixed drinks can be simplified. An essential advantage of this configuration is to be regarded in that the accessibility to the housing of the mixed drink producing apparatus is simplified. In particular the accessibility to the containers and/or other further components in the housing is thereby allowed. It can then be provided that in the extracted state the interior of the housing of the mixed drink producing apparatus can be accessed for example via openings in side walls closable by flaps.

The drink producing apparatus is also to be referred to as mixed drink producing apparatus if the drink to be dispensed has at least one liquid and an addition medium or at least two different liquids.

With indications of “top”, “bottom”, “front”, “rear”, “horizontal”, “vertical”, “depth direction”, “width direction”, “height direction” etc., the positions and orientations with intended use and intended arrangement of the apparatus and with an observer then standing in front of the apparatus and looking towards the apparatus are specified.

Further features of the invention are apparent from the claims, the figures and the description of figures. The features and feature combinations mentioned above in the description as well as the features and feature combinations mentioned below in the description of figures and/or shown in the figures alone are usable not only in the respectively specified combination, but also in other combinations without departing from the scope of the invention. Thus, implementations are also to be considered as encompassed and disclosed by the invention, which are not explicitly shown in the figures and explained, but arise from and can be generated by separated feature combinations from the explained implementations. Implementations and feature combinations are also to be considered as disclosed, which thus do not have all of the features of an originally formulated independent claim. Moreover, implementations and feature combinations are to be considered as disclosed, in particular by the implementations set out above, which extend beyond or deviate from the feature combinations set out in the relations of the claims.

### BRIEF DESCRIPTION OF THE DRAWINGS

Below, embodiments of the invention are explained in more detail based on schematic drawings. There show:

FIG. 1 a perspective partial representation of an embodiment of a household refrigeration apparatus according to the invention;

FIG. 2 a schematic representation of a refrigeration circuit of the household refrigeration apparatus, to which a chamber of the overall container is thermally coupled;

FIG. 3 a schematic representation of an embodiment of an overall container of the mixed drink producing apparatus; and

FIG. 4 a schematic representation of an embodiment of an overall container of the mixed drink producing apparatus.

### PREFERRED EMBODIMENTS OF THE INVENTION

In the figures, identical or functionally identical elements are provided with the same reference characters.

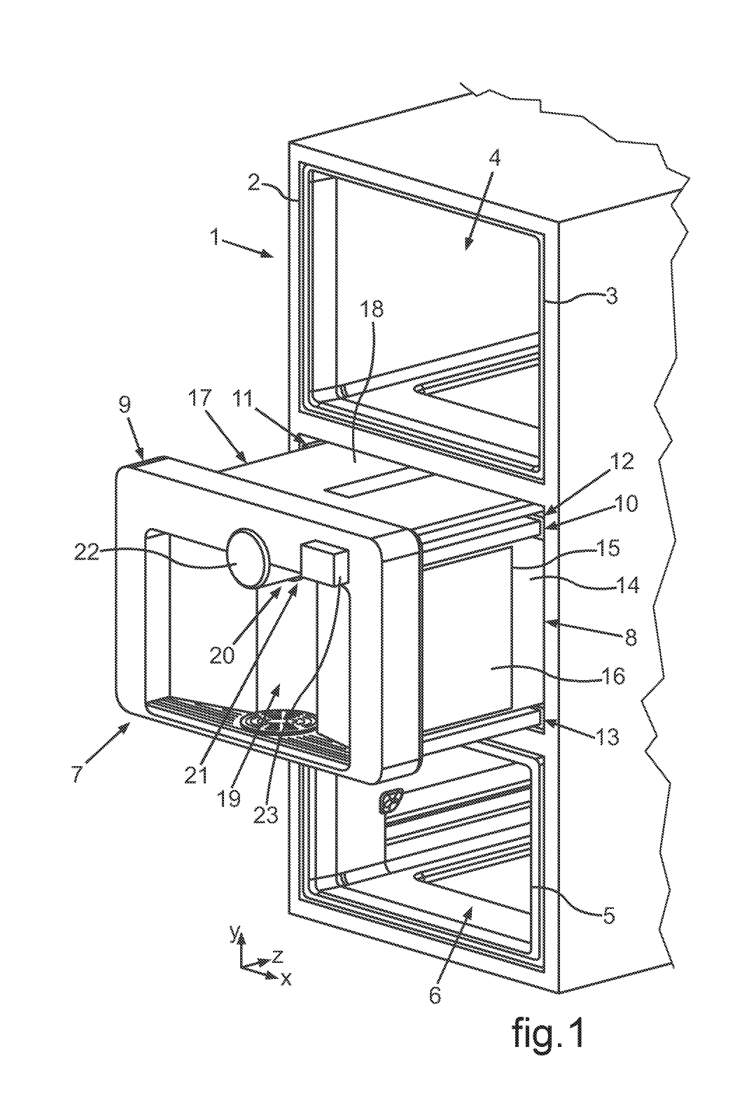

In FIG. 1, a household refrigeration apparatus 1 is illustrated in certain areas in a simplified perspective representation. Here, the household refrigeration apparatus 1 is for example a combined refrigerator-freezer. The household refrigeration apparatus 1 is formed for storing and preserving food. It includes a housing 2, in which a first interior container 3 is disposed. Walls of the interior container 3 bound a first receiving space 4 for food, wherein this receiving space 4 is a refrigerating compartment.

Moreover, the household refrigeration apparatus 1 includes a further interior container 5, which bounds a second receiving space 6 with its walls, which is a freezing compartment. The two receiving spaces 4 and 6 are separated from each other. In the shown embodiment, the receiving spaces 4 and 6 are disposed one above the other in vertical direction and thus in height direction (y-direction). In the embodiment, they are preferably closable by non-shown, respectively separate doors, which are in particular pivotably fastened to the housing 2.

Moreover, the household refrigeration apparatus 1 includes a mixed drink producing apparatus 7.

However, the mixed drink producing apparatus 7 can also be formed as a separate independent apparatus and thus be installed independently of a household refrigeration apparatus 1 and operable independently thereof.

The mixed drink producing apparatus 7 is disposed in a receiving area 8 of the housing 2. This receiving area 8 is separated from the receiving spaces 4 and 6. It can be provided that the receiving area 8 is bounded by walls of a separate interior container, which is also foamed in the housing 2. However, the receiving area 8 can also be formed integrated in the interior container 3 or the interior container 5.

In the embodiment, it is provided that the receiving area 8 is disposed between the receiving space 4 and the receiving space 6 in height direction.

The mixed drink producing apparatus 7 is disposed accessible from the front side and thus from the front and the visible side. In particular, it is not closable and thus not coverable on the front side by a door.

The mixed drink producing apparatus 7 has a housing 9.

In the embodiment, it is provided that the housing 9 and thus the entire mixed drink producing apparatus 7 can be extracted from and again retracted into the receiving area 8 in depth direction and thus in horizontal direction corresponding to the z-direction corresponding to a drawer. In FIG. 1, the completely extracted state is shown.

Here, it is preferably provided that the horizontal displaceability is formed by a displacing device 10, which has multiple supporting positions. In the embodiment, it is provided that the displacing device 10 includes at least two, in particular four supporting positions. In the embodiment, they are formed as rails, which can also be extraction rails. In particular, here are disposed a first rail 11 in an upper left corner area, a second rail 12 in the upper right corner area, a third rail 13 in the lower right corner area and a further rail not recognizable in FIG. 1 in the lower left corner area. By this four-position support, a very secure and spread- and tilt-proof displacement, respectively, of the housing 9 is allowed.

Thus, the mixed drink producing apparatus 7 is advantageously displaceably supported in the interior container 8. Advantageously, the displacing device 10 also has an extraction stop, by which the drink apparatus formed in particular as a mixed drink producing apparatus 7 is secured in position in a completely extracted position shown in FIG. 1. Thus, over-extraction cannot be effected such that the mixed drink producing apparatus 7 cannot fall out to the front and tilt downwards, respectively.

Advantageously, it is also provided that the displacing device 10 has a displacing protection, by which the mixed drink producing apparatus 7 is disposed extraction-secured in the position completely retracted into the receiving area 8. Thereby too, undesired slipping out or protruding to the front then present is avoided. Undesired leakage or dripping of a liquid or hitting thereto is thereby prevented. This displacement protection can be a locking device. However, in addition or instead of it, a magnetic mount can also be provided.

Advantageously, an access 15 is formed at a vertical sidewall 14 of the housing 9, which is closed by a flap 16. After opening the flap 16, the interior of the housing 9 can be accessed such that the simple and unrestricted accessibility is allowed for purposes of exchange or filling. Additionally or instead of it, it can also be provided that a corresponding access is formed at an opposing further vertical sidewall 17 and/or at least one such access 15 is formed at a ceiling wall 18 of the housing 9.

Moreover, the mixed drink producing apparatus 7 includes a recess or placing bay 19 on the front side, into which a drinking vessel can be placed, by which the mixed drink to be produced and dispensed by the mixed drink producing apparatus 7 can then be collected. The mixed drink producing apparatus 7 includes a dispensing unit 20 with in particular a single outlet or a dispensing opening 21. Preferably, it can be provided that an own outlet is respectively present for discharging each liquid from a container. Moreover, it can also be provided that an additive in powder form or gel form or further liquid form can be admixed to this mixed drink to be produced, which can be produced and thus mixed from at least two different liquids. Thereto, it can in particular be provided that a capsule receptacle 22 is formed, into which a capsule having the mentioned additive or an addition medium can be inserted. Upon dispensing the mixed drink, this ingredient or additive is then removed from the capsule and added to the mixed drink in particular before or after dispensing into the drinking vessel effected via the dispensing opening 21.

Moreover, it can in particular be provided that the mixed drink producing apparatus 7 has a capsule storage 23 or a capsule stock. A capsule or multiple capsules can be stored in this capsule storage 23 such that they are always present locally at the apparatus itself. In an advantageous implementation, it can be provided that this capsule storage 23 is cooled such that the capsules located therein can also be stored correspondingly cooled.

Preferably, it is provided that the capsule storage 23 can be opened by push-push mechanics and the capsules received therein are then freely accessible for example in the form of a displaceable storage in the form of a rail and for example can then be simply removed from above.

Moreover, it can also be provided that the mixed drink producing apparatus 7 has a cartridge for admixing carbon dioxide into the mixed drink. Thereto, the accessibility for cartridge exchange is allowed via at least one present access 15. In an advantageous implementation, it is provided that the mixed drink producing apparatus 7 is connected to a water connection external to household apparatus such that supply of water is for example allowed via a house water network. This has the additional advantage that a liquid to be added to the mixed drink as water does not have to be stored in a largely dimensioned container in the mixed drink producing apparatus 7 but that this container can then be smaller dimensioned and can be refilled depending on demand and adapted to situation. It can then also be provided that such a water supply for producing the mixed drink is not supplied from the tank or the container provided for receiving this liquid in the mixed drink producing apparatus 7, but additionally or instead thereof can also be passed directly from this line to the dispensing unit 20 and thus also to the dispensing opening 21.

Thereby, in particular in production of hot drinks instead of a cold drink, the required energy for heating is reduced since the initial temperature of the water is higher. If carbonization of the mixed drink should then be desired, thus, this can be allowed via admixture of carbonized cold water, which is cooled in the mixed drink producing apparatus 7, or via a carbonized second liquid, which is then present in the second container.

It is in particular provided that the mixed drink producing apparatus 7 has a first container, in which a first liquid with a first freezing point, in particular water, is then provided or stored to then provide it for producing and dispensing a mixed drink depending on demand. Moreover, the mixed drink producing apparatus 7 includes a second container separated therefrom, which is formed for receiving a second liquid different from the first liquid, which has a freezing point different form the first liquid. In particular, the first liquid is water and the second liquid is alcohol such that the mixed drink can also be an alcoholized mixed drink.

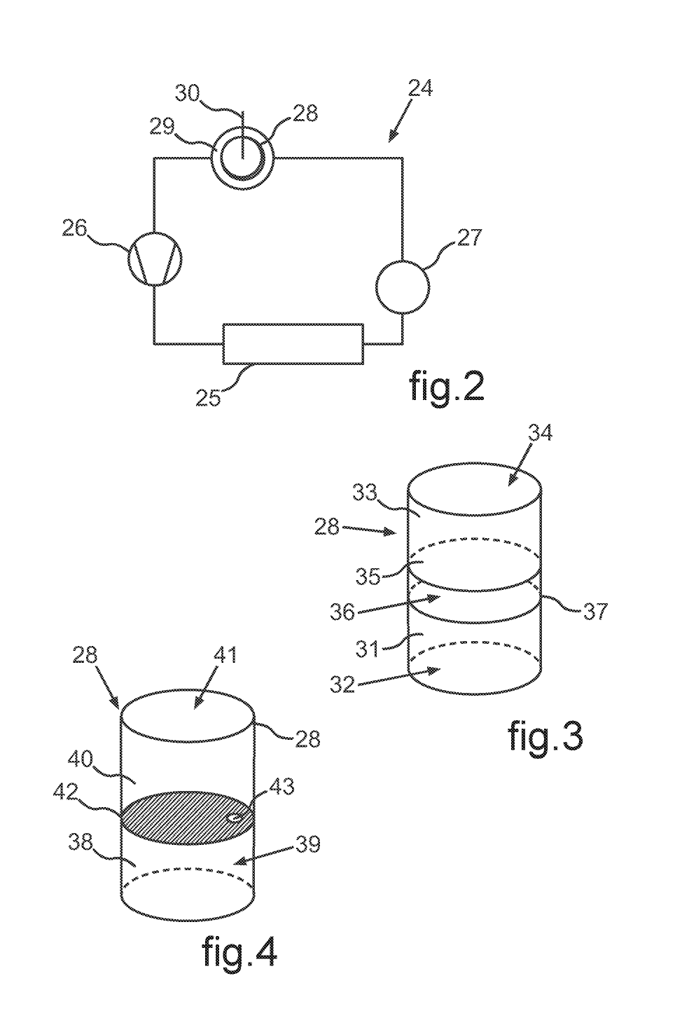

In FIG. 2, a refrigeration circuit 24 is shown in a simplified representation, which is a component of the household refrigeration apparatus 1, in particular of the mixed drink producing apparatus 7. The refrigeration circuit 24 includes a condenser 25 as well as a compressor 26. In particular, a drier 27 can also be present, by which residual humidity arising in the refrigeration circuit 24 is “dried” or bound.

An in particular integral overall container 28 of the mixed drink producing apparatus 7 is thermally coupled to this refrigeration circuit 24. In the embodiment, it is provided that an evaporator 29 of the refrigeration circuit 24 is thermally coupled to this overall container 28. In particular, the evaporator 29 is thermally coupled to an outer side of the overall container 28, in particular abutting thereon.

Moreover, at least one discharge line 30 is also shown in symbolic manner, which leads from the overall container 28 to the dispensing unit 20, in particular to the dispensing opening 21.

In FIG. 3, an embodiment of an overall container 28 is shown in a schematic representation. This in particular integral container has a first chamber 31 presenting a first dispensing container 32 in the shown implementation. Moreover, a second chamber 33 is formed in the overall container 28 in the shown embodiment, which presents a second dispensing container 34. The first dispensing container 32 is formed for receiving a first liquid, in particular water. The second dispensing container 34 is formed for receiving a second liquid, in particular alcohol or an alcohol containing liquid. Therefore, liquids different with regard to their freezing point are received in the chambers 31 and 33. The two chambers 31 and 33 immediately adjoin to each other and are separated from each other by a partition 35. The partition 35 constitutes a bottom of the chamber 33 and a ceiling of the chamber 31.

The overall container 28 can for example be formed of plastic, in particular be integrally produced.

According to the representation in FIG. 3, it is provided in this embodiment that the chambers 31 and 33 are disposed one above the other in vertical direction (y-direction) and thus in height direction of the household refrigeration apparatus 1 and also of the mixed drink producing apparatus 7 in this context, wherein the first chamber 31 is disposed below the second chamber 33.

Moreover, it is provided that a volume area is formed as a thermal insulation area 36 between the chambers 31 and 33. This can be an explicitly separated volume area thus formed by partitions. In the embodiment, it is provided that this thermal insulation area 36 is an air volume and thus a thermal insulation effect between the liquids in the first chamber 31 and the second chamber 33 is formed only by the air located therein. This thermal insulation area 36 is bounded to the top by the partition 35 and defined to the bottom by a maximum filling level indicator 37, which is in particular formed as a mark on the wall bounding the chamber 31. Thus, if the first liquid, which can be filled into the first chamber 31, is filled in only maximally to this filling level boundary 37, thus, this thermal insulation area 36 is sufficiently dimensioned with regard to its volume in order not to cause undesired influence with regard to the temperature transfer between the chambers 31 and 33 and thus also between the liquids located therein. Freezing of the water in the chamber 31 due to the colder alcohol in the chamber 33 in particular in the top volume area facing the chamber 33 of the water present as the first liquid is thereby prevented.

The chambers 31 and 33 are connected to the dispensing unit 20 and in particular the dispensing opening 21 via the discharge line 30 or via then optionally respectively separate discharge lines such that a mixed drink of the two liquids is already dispensed from the chambers 31 and 33 at the dispensing opening 21.

In FIG. 4, a further embodiment of an overall container 28 is shown. In this implementation, a chamber 38 of a dispensing container 39 is formed. In the overall container 28, moreover, a further chamber 40 is formed, which presents a chamber of a storage container 41. The storage container 41 is a reservoir and in particular a cooling container, in which the same liquid, which is then also to be contained in the dispensing container 39 and thus in the chamber 38, is contained, wherein the chambers 38 and 40 are coupled in liquid conducting manner. By the additional storage container 41 in the form of the chamber 40, therefore, a larger amount of this same liquid can be provided in the mixed drink producing apparatus 7, and by the separation of the chambers 38 and 40, the respective liquid amounts of this same liquid can be individually treated, in particular individually cooled. It is provided that the chambers 38 and 40 are separated by a partition 42, wherein this partition 42 preferably has a liquid passage element 43. In particular, it can for example be a valve. Thereby, the conduction of the liquid from the chamber 40 and thus from the storage container 41 into the chamber 38 located below and thus the dispensing container 39 can be very adequately effected. In this configuration, the chamber 40 is not directly connected to the dispensing unit 20 and thus also the dispensing opening 21 by a delivery line or discharge line, but is only connected to the chamber 38. Only this chamber 38 is then connected to the dispensing unit 20, in particular the dispensing opening 21, via a discharge line 30 or delivery line.

It can also be provided that at least one further chamber, for example the chamber 40 relating to the storage container 41, is present in the embodiments according to FIG. 3 such that the functionality of storage and provision is allowed for at least one of the liquids as they are present in the chambers 31 and 33. In this context, it can in particular also be provided that two storage containers and thus two further chambers are present in the overall container 28 according to FIG. 3. Thereby, an individual storage container and thus each one further individual storage chamber are also associated with each chamber 31 and 33 presenting the dispensing containers 32 and 34.

It can be provided that the cooling of the individual chambers 31 and 33 or 38 and 40 is effected by respectively separate evaporators of the refrigeration circuit 24 such that cooling respectively effected independently of each other can be performed.

Alternatively to cooling by the refrigeration circuit 24, it can also be provided that at least one conveying line is for example provided, which is coupled to the chamber 33 and is disposed extending in the volume of the lower chamber 31 at least in sections. By such a configuration, the liquid from the chamber 33, in particular the cooler alcohol, can then be conducted through this conveying line and thereby cold energy can then be correspondingly transferred to the first liquid, in particular the water, in the chamber 31 and then this water can thus also be cooled. It can also be provided that a conveying line is present, in which the liquid from the chamber 31, in particular the water, is then conducted through this line, wherein this conveying line is then disposed extending in the volume of the chamber 33 at least in sections. Thereby too, cooling of the water in the conveying line is achieved by effect of the colder alcohol in the chamber 33.

In these configurations, it is in particular provided that a conveying unit, in particular a pump, is present, by which the liquid in the respective conveying line can be conveyed out such that a corresponding liquid does not stop in the conveying line and thus freezing of the liquid in the conveying line is prevented.

If a further chamber area for a further storage container and a further chamber area for a further dispensing container are formed in the embodiment according to FIG. 4, thus, they can then be formed stacked thereover in vertical direction. This means that it is then preferably provided in vertical direction that the uppermost chamber is formed for storing and thus pre-cooling the liquid with the lower freezing point, in particular alcohol, following to the bottom the chamber forming the dispensing container of this liquid with the lower freezing point is then formed, again subsequently to the bottom the chamber presenting the further storage container for the liquid with the higher freezing point is then formed and again subsequently to the bottom and thus finally that chamber is formed, which presents the dispensing container of the liquid with the higher freezing point.

### LIST OF REFERENCE CHARACTERS

1 Household refrigeration apparatus
2 housing
3 interior container
4 first receiving space
5 interior container
6 second receiving space
7 mixed drink producing apparatus
8 receiving area
9 housing
10 displacing device
11 rail
12 rail
13 rail
14 sidewall
15 access
16 flap
17 sidewall
18 ceiling wall
19 placing bay
20 dispensing unit
21 outlet
22 capsule receptacle
23 capsule storage
24 refrigeration circuit
25 condenser
26 compressor
27 drier
28 overall container
29 evaporator
30 discharge line
31 chamber
32 dispensing container
33 chamber
34 dispensing container
35 partition
36 insulation area
37 filling level boundary
38 chamber
39 dispensing container
40 chamber
41 storage container
42 partition
43 liquid passage element

1. A mixed drink producing apparatus, comprising:
a dispensing unit for dispensing liquid from the mixed drink producing apparatus,
a first dispensing container, which is formed for receiving a first liquid having a first freezing point and addable to a mixed drink by the mixed drink producing apparatus, wherein
the first dispensing container is connected to a dispensing unit of the mixed drink producing apparatus for conducting the first liquid from the first dispensing container to the dispensing unit, and
a second dispensing container, which is formed for receiving a second liquid having a second freezing point different from the first freezing point and addable to a mixed drink by the mixed drink producing apparatus, wherein
the second dispensing container is connected to the dispensing unit of the mixed drink producing apparatus for conducting the second liquid from the second dispensing container to the dispensing unit,
the first dispensing container and the second dispensing container are formed as chambers in an overall container, and
at least one partition in the overall container, by which the chamber of the first dispensing container is separated from the chamber of the second dispensing container.

2. The mixed drink producing apparatus according to claim 1, wherein the chambers of the dispensing containers are formed one above the other viewed in vertical direction.

3. The mixed drink producing apparatus according to claim 2, wherein the first chamber forming the first dispensing container is formed for receiving a first liquid with a higher freezing point than the second liquid, and the first chamber is formed below the second chamber forming the second dispensing container.

4. The mixed drink producing apparatus according to claim 2, wherein a volume area as a thermal insulation area is formed between the chambers.

5. The mixed drink producing apparatus according to claim 4, wherein the thermal insulation area is an air volume.

6. The mixed drink producing apparatus according to claim 4, wherein the thermal insulation area is bounded to the top by the partition and is dimensioned to the bottom by a mark spaced from the partition and presenting a maximum filling level boundary for filling the dispensing container with the liquid.

7. The mixed drink producing apparatus according to claim 1, wherein the mixed drink producing apparatus has a refrigeration circuit, to which at least one chamber of the overall container is thermally coupled and can be cooled by at least the chamber of this dispensing container.

8. The mixed drink producing apparatus according to claim 7, wherein the refrigeration circuit has an evaporator, which is thermally coupled to the chamber to be cooled, and/or has a further evaporator, which is thermally coupled to the other chamber.

9. The mixed drink producing apparatus according to claim 7, wherein the refrigeration circuit is thermally coupled to both chambers.

10. The mixed drink producing apparatus according to claim 1, wherein the mixed drink producing apparatus has a liquid line for conducting a liquid from a chamber, wherein the liquid line is disposed extending in the other chamber in sections such that cooling of the liquid flowing in the liquid line is effected by the liquid located in the chamber, in which the liquid line is disposed extending, or cooling of the liquid in the liquid line is effected by the liquid located in this chamber.

11. The mixed drink producing apparatus according to claim 10, wherein the mixed drink producing apparatus has a pump, by which liquid in the liquid line can be pumped off at least in the section extending in the chamber if cooling is not required.

12. The mixed drink producing apparatus according to claim 1, wherein the mixed drink producing apparatus has at least one storage container for storing the liquid of the associated dispensing container in addition to the first dispensing container and/or to the second dispensing container, wherein the storage container is connected to the associated dispensing container for conducting the liquid from the storage container to the associated dispensing container, and the storage container is formed as a chamber in the common overall container.

13. A household refrigeration apparatus with a housing, in which a receiving space for food is formed, and with a mixed drink producing apparatus having:
a dispensing unit for dispensing liquid from the mixed drink producing apparatus,
a first dispensing container, which is formed for receiving a first liquid having a first freezing point and addable to a mixed drink by the mixed drink producing apparatus, wherein
the first dispensing container is connected to a dispensing unit of the mixed drink producing apparatus for conducting the first liquid from the first dispensing container to the dispensing unit, and
a second dispensing container, which is formed for receiving a second liquid having a second freezing point different from the first freezing point and addable to a mixed drink by the mixed drink producing apparatus, wherein
the second dispensing container is connected to the dispensing unit of the mixed drink producing apparatus for conducting the second liquid from the second dispensing container to the dispensing unit,
the first dispensing container and the second dispensing container are formed as chambers in an overall container, and
at least one partition in the overall container, by which the chamber of the first dispensing container is separated from the chamber of the second dispensing container.

14. A drink producing apparatus having:
a dispensing unit for dispensing liquid from the drink producing apparatus,
a first dispensing container, which is formed for receiving a first liquid having a first freezing point and addable to a drink by the drink producing apparatus, wherein
the first dispensing container is connected to the dispensing unit of the drink producing apparatus for conducting the first liquid from the first dispensing container to the dispensing unit, and
in addition to the first dispensing container, a first storage container for storing the first liquid, which is connected to the first dispensing container for conducting the first liquid from the first storage container to the first dispensing container, and
the first dispensing container and the first storage container are formed as chambers in a common overall container.

15. The drink producing apparatus according to claim 14, wherein the chambers of the dispensing container and the storage container are formed one above the other viewed in vertical direction.

16. The drink producing apparatus according to claim 14, wherein the chambers directly adjoin to each other and are separated by a partition, and a liquid passage element is formed in the partition, by which the chambers are connected for conducting liquid from the storage container into the dispensing container.

17. The drink producing apparatus according to claim 16, wherein the liquid passage element is a valve or a unidirectional membrane.

18. The drink producing apparatus according to claim 16, wherein the storage container is a cooling container, in which liquid is storable as a stock cooled at a temperature, which is equal to or higher than the temperature of this liquid in the associated dispensing container.

19. The drink producing apparatus according to claim 14, wherein the drink producing apparatus has at least one second dispensing container, which is formed for receiving a second liquid having a second freezing point different from the first freezing point and addable to a drink by the drink producing apparatus and which is connected to the dispensing unit of the drink producing apparatus for conducting the second liquid from the second dispensing container to the dispensing unit, wherein the second dispensing container is formed as a chamber in the overall container.

20. A household refrigeration apparatus with a housing, in which a receiving space for food is formed, and with a drink producing apparatus having:
a dispensing unit for dispensing liquid from the drink producing apparatus,
a first dispensing container, which is formed for receiving a first liquid having a first freezing point and addable to a drink by the drink producing apparatus, wherein
the first dispensing container is connected to the dispensing unit of the drink producing apparatus for conducting the first liquid from the first dispensing container to the dispensing unit, and
in addition to the first dispensing container, a first storage container for storing the first liquid, which is connected to the first dispensing container for conducting the first liquid from the first storage container to the first dispensing container, and
the first dispensing container and the first storage container are formed as chambers in a common overall container.
